(19) United States
(12) Patent Application Publication
(10) Pub. No.: US 2006/0138303 A1
(43) Pub. Date: Jun. 29, 2006

(54) Photo detector device for single photon count apparatus

(76) Inventors: Jiang Lan, Beijing (CN); Jinsheng Yu, Beijing (CN); Xiaolin Yang, Beijing (CN); Xiaodong Wu, Beijing (CN)

Correspondence Address: DARBY & DARBY P.C., P. O. BOX 5257, NEW YORK, NY, 10150-5257, US

(21) Appl. No.: 11/152,691

(22) Filed: Jun. 13, 2005

(30) Foreign Application Priority Data
Dec. 24, 2004 (CN) 200410104870.X

(51) Int. Cl. H01J 40/14; H01J 43/30

(52) U.S. Cl. 250/207; 250/214 VT

(57) ABSTRACT

A photo detector device for single photon count apparatus includes a casing; a detect window for inputting photons from a detected sample; a photo detector for receiving said photons through said window; a socket for holding said photo detector; a voltage-dividing circuit board for powering the photo detector; and a pre-processing circuit board for processing the electric signal from the photo detector, wherein said voltage-dividing circuit board and said pre-processing circuit board are compactly disposed on the back of the socket, then said voltage-dividing circuit board said pre-processing circuit board, said socket and said photo detector are integrally placed in the casing capable of shielding light and protecting against magnetization.

This application claims priority to No. 200410104870.X filed on Dec. 24, 2004.

### FIELD OF THE INVENTION

The present invention relates to a single photon count apparatus, particularly to a photo detector device for single photon count apparatus.

### BACKGROUND OF THE INVENTION

Test for various hormones, medicines, vitamins, tumors or infection-associated substance is a basic work for a hospital. Traditional radioactive immunoassay has some drawbacks, since it is of short half life, difficult to store, harmful to the operator and the environment, and has low sensitivity. In 1990's of 20th century, photo bio-marker test method is developed with chemical luminescence, which has advantages in simplicity, efficiency and safety, and has high sensitivity. The method is now applied to clinic diagnosis.

A single photon counting apparatus is a detecting device for detecting a reagent with chemical luminescence, which is used to detect the very weak light intensity emitted by the tested sample with single photon counting method.

Compared with traditional radioactive immunoassay, the single photon counter apparatus has, when used to test various hormones, medicines, vitamins, tumors or infection-associated substance in a hospital, advantages in simplicity, efficiency and safety, and has high sensitivity.

In general, the Photo Detector circuit for single photon counting apparatus of the prior art comprises four parts: 1. a photo detector, disposed in a light-shielding casing with electromagnetic resistant; 2. a pre-amplifier for amplifying a weak signal output by said photo detector; 3. a voltage comparator for removing the noise output by said pre-amplifier and for converting the analog electric signal over a threshold into an electric pulse signal; and 4. counter for counting the pulses output by the voltage comparator in some time interval and for outputting a counting value.

Since the detected emission intensity is very weak, the output signal of photo detector is also very weak, the output pulse width of the photo detector is very narrow, this requires a processing circuit with high frequency limit, and the processing circuit is easily disturbed by noise and disperse wave.

### SUMMARY OF THE INVENTION

An object of the invention is to provide a photo detector device capable of preventing itself from interference and of reducing noise level to improve detecting sensitivity.

In accordance with an aspect of the invention, a photo detector device for single photon count apparatus, comprising: a casing; a detect window for inputting photons from a tested sample; a photo detector for receiving said photons through said window; a socket for holding said photo detector; a voltage-dividing circuit board for powering the photo detector; and a pre-processing circuit board for processing the electric signal from the photo detector, wherein said voltage-dividing circuit board and said pre-processing circuit board are compactly disposed on the back of the socket, then said voltage-dividing circuit board said pre-processing circuit board, said socket and said photo detector are integrally placed in the casing capable of shielding light and protecting against magnetization.

In accordance with another aspect of the invention, wherein said photo detector is a photomultiplier.

The photo detector device for single photon count apparatus ensures a high frequency characteristic of the processing circuit with reduction of electromagnetic interference and noise level.

### BRIEF DESCRIPTION OF THE DRAWINGS

The foregoing and other advantages of the invention will become apparent upon reading the following detailed description and upon reference to the drawing in which:

FIG. 1 shows an arrangement of the photo detector device for single photon count apparatus in accordance with an embodiment of the invention.

### DETAILED DESCRIPTION OF THE INVENTION

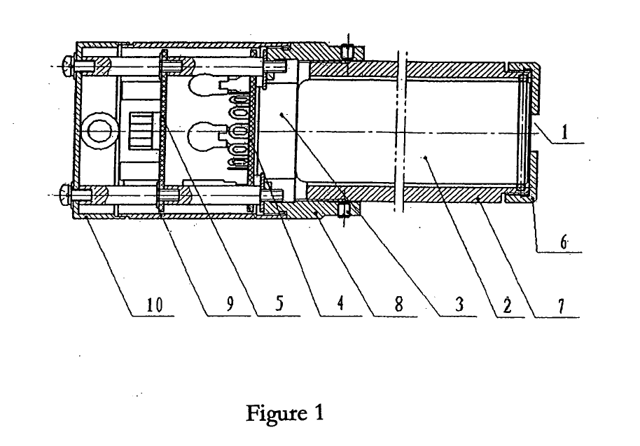

As shown in FIG. 1, in accordance with an embodiment of the invention, in a photo detector device for single photon count apparatus, photons from a tested sample is input into detect window 1. Photomultiplier 2 acts as a photo detector for receiving said photons through said window. Said photomultiplier is plugged in socket 3. Voltage-dividing circuit board 4 supplies power for a plurality of dynodes of said photomultiplier. Pre-processing circuit board 5 processes the electric signal from the photomultiplier. Said pre-processing circuit generally includes a pre-amplifying circuit, a voltage comparator circuit and a high rate counter (divider). In order to ensure the high frequency characteristic of the processing circuit with reduction of electromagnetic interference and noise figure, Voltage-dividing circuit board 4 and pre-processing circuit board 5 are most compactly disposed on the back of socket 3, then said voltage-dividing circuit board, said pre-processing circuit board, said socket and said photo detector are together placed in casing 6, 7, 8 capable of shielding light and protecting against magnetization.

An arrangement of photo detector device for single photon count apparatus has been disclosed for ensuring the high frequency characteristic of the processing circuit with reduction of electromagnetic interference and noise figure. Although the present invention has been described in accordance with the embodiment shown, one of ordinary skill in the art will readily recognize that there could be variations to the described embodiment and those variations would be within the spirit and the scope of the present invention. Accordingly, many modifications may be made by skilled person in the art without departing from the spirit and scope of the appended claims.

What is claimed as new and desired to be protected by Letters Patent of the United States is:

1. A photo detector device for single photon count apparatus, comprising:
a casing;
a detect window for inputting photons from a detected sample;
a photo detector for receiving said photons through said window; a socket for holding said photo detector;
a voltage-dividing circuit board for powering the photo detector; and
a pre-processing circuit board for processing the electric signal from the photo detector,
wherein said voltage-dividing circuit board and said pre-processing circuit board are compactly disposed on the back of the socket, then said voltage-dividing circuit board, said pre-processing circuit board, said socket and said photo detector are integrally placed in the casing capable of shielding light and protecting against magnetization.

2. A photo detector device of claim 1, wherein said photo detector is a photomultiplier.
